(19) United States
(12) Patent Application Publication
(10) Pub. No.: US 2011/0141019 A1
(43) Pub. Date: Jun. 16, 2011

(54) INPUT DEVICE MULTI-DIRECTION CONTROL PROCESSING METHOD

(76) Inventors: Chih-Ming TSAO, Zhonghe City (TW); Ya-Ting Cheng, Zhonghe City (TW)

(21) Appl. No.: 12/963,345

(22) Filed: Dec. 8, 2010

(30) Foreign Application Priority Data
Dec. 10, 2009 (TW) 098142303

(51) Int. Cl. G06F 3/033

(52) U.S. Cl. 345/163

(57) ABSTRACT

Used in an input device having a housing thereof sensor modules and a circuit substrate carrying a control module, a touch panel, a displacement sensor module, a transmission module and a power supply module to control a computer comprising a driver software, an input device multi-direction control processing method is to detect the location of the presence of an external object on the surface of the housing of the input device by the sensor modules so that the sensor modules provide location signals to the control module upon the presence of an external object at the surface of the housing, for enabling the control module to store the location signals and to further transmit the location signals and displacement coordinate signals received from the displacement sensor module to the driver software of the computer for calculating a new coordinate system and translating the new coordinate system into a track signal for cursor control.

This application claims the priority benefit of Taiwan patent application number 098142303, filed on Dec. 10, 2009.

### BACKGROUND OF THE INVENTION

1. Field of the Invention

The present invention relates to computer input device operation control technology and more particularly, to an input device multi-direction control processing method in which the input device transmits the location signals of the external object at the surface of the housing thereof and displacement coordinate signals to the computer, enabling the driver software of the computer to calculate a new coordinate system and to translate the new coordinate system into a track signal for cursor control.

2. Description of the Related Art

In computer systems, keyboard and mouse are the most popularly used input devices. Further, a mouse can be used to substitute for the directional keys of a keyboard for displacement track input. In a computer operating system, mouse has become a requisite peripheral apparatus. Many application software and instructions can be conveniently operated and executed through a mouse. The use of a mouse greatly facilitates the operation of a computer system.

Normally, a mouse has a directional characteristic, i.e., when using a mouse, the user must hold the mouse in a particular direction for operation. The internal control module of a mouse can simply determine the displacement track in this particular direction. This limitation causes inconvenience in use. A conventional mouse A, as shown in FIG. 7, has a front side A1, a rear side A2 and opposing left side A3 and right side A4. When using the mouse A, the user must keep the front side A1 and the rear side A2 in Y-axis direction and the opposing left side A3 and right side A4 in X-axis direction so that the mouse A can be operated accurately. Further, the mouse A comprises a left button A11, a right button A12 and a scroll button A13 on the front side A1. Therefore, this mouse A must be operated by the right hand and kept in one single direction. Operating this design of mouse is not convenient to all different users.

To fit right-handed and left-handed users, prior art discloses a mouse device comprising a mouse left button and a mouse right button for producing a respective clicking signal upon triggering by a user, and a mode-switching key for switching between a left-handed operation mode and a right-handed operation mode. When a user clicks the mouse left button or mouse right button, the mouse left button or mouse right button will produce a respective clicked signal subject to the left-handed operation mode or right-handed operation mode, and the clicked signal will be transmitted to the computer for cursor control.

However, the aforesaid left-handed and right-handed dual-mode mouse device still must be kept in a particular direction for accurate operation. This directional limitation limits the configuration design of the mouse device and its use.

Therefore, it is desirable to provide an input device that eliminates the aforesaid problems.

### SUMMARY OF THE INVENTION

The present invention has been accomplished under the circumstances in view. It is one external object of the present invention to provide a multi-direction control processing method for input device, which eliminates the drawbacks of the conventional mouse devices.

To achieve this and other objects of the present invention, an input device multi-direction control processing method used in an input device having a housing thereof at least one sensor module and a circuit substrate carrying a control module, a touch panel, a displacement sensor module, a transmission module and a power supply module to control a computer comprising a receiver module and a driver software. When the sensor modules sense the presence of an external object on the surface of the housing of the input device, they will transmit at least one location signal to the control module, for enabling the control module to store the at least one location signals. When the housing is moved, the displacement sensor module detects the movement and provides displacement coordinate signals to the control module. Thereafter, the control module transmits every received location signal and displacement coordinate signal to the receiver module of the computer. Upon receipt of every location signal and displacement coordinate signal, the receiver module transmits the signals to the driver software of the computer, enabling the driver software to calculate a new coordinate system and to further translate the new coordinate system into a track signal for the operating system of the computer for cursor control.

Further, when the sensor modules sensed the location of the external object on the surface of the housing of the input device to provide respective location signals to the computer, the driver software of the computer determines the type of the external object at the housing of the input device subject to the coordinate values of the location signals, knowing the thumb or little finger of the user to be rested on the left or right side of the housing, i.e., knowing the user to be a left-handed user or right-handed user. Thus, the invention allows the use of the input device by a left-handed person as well as a right-handed person.

### BRIEF DESCRIPTION OF THE DRAWINGS

FIG. 1 is a perspective view of an input device constructed in accordance with the present invention.

FIG. 2 is an exploded view of the input device shown in FIG. 1.

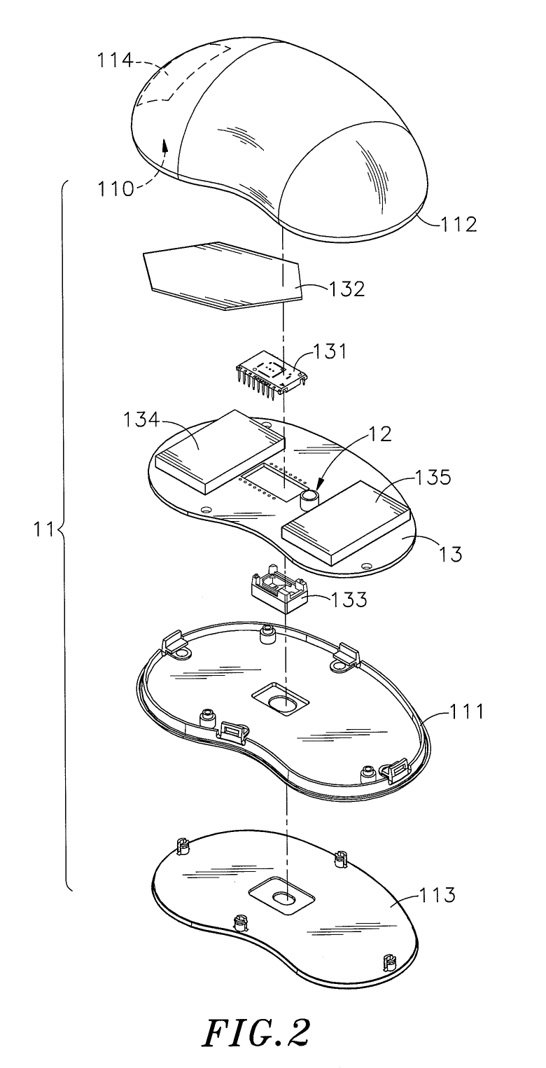

FIG. 3 is a circuit block diagram of the input device shown in FIG. 1.

FIG. 4 is an operation flow chart of the present invention.

FIG. 5 is a schematic drawing illustrating an operation status of the input device in accordance with the present invention.

FIG. 6 is a perspective view of an alternate form of the input device in accordance with the present invention.

FIG. 7 is a top plain view of a mouse according to the prior art.

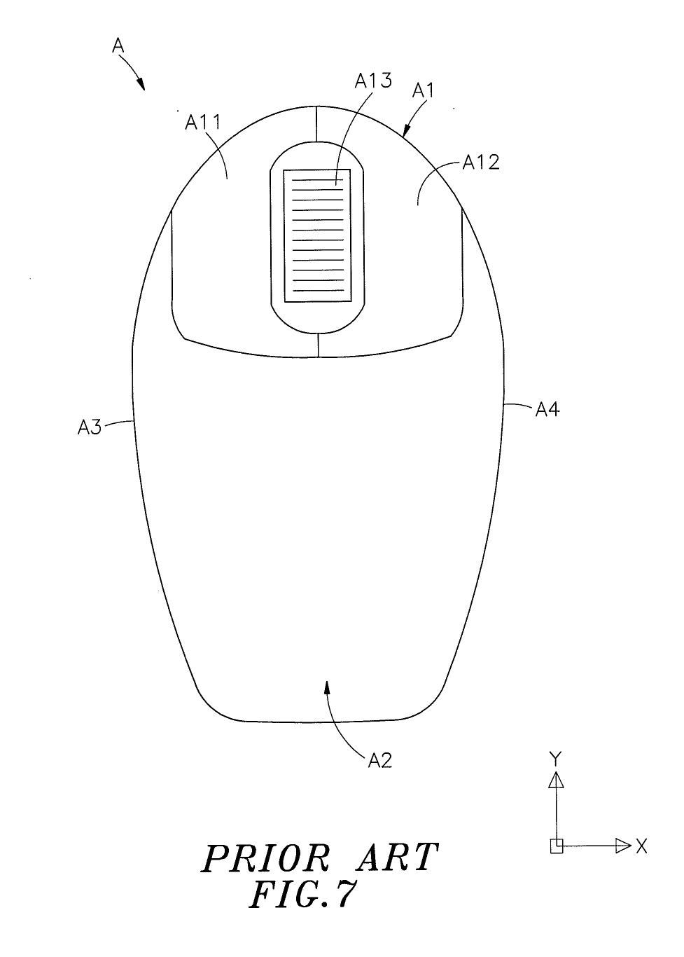

### DETAILED DESCRIPTION OF THE PREFERRED EMBODIMENT

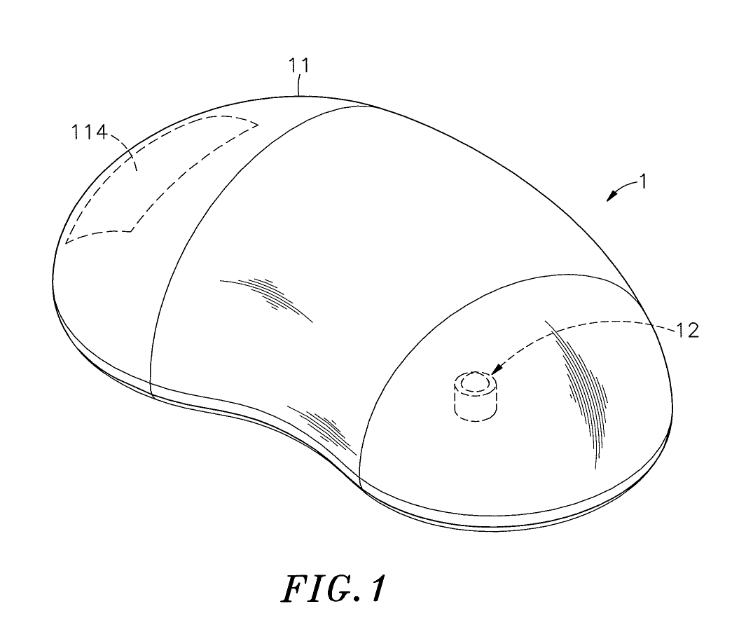

Referring to FIGS. 1˜3, an input device multi-direction control processing method in accordance with the present invention is to be performed through an input device 1 and a computer 2. The input device 1 comprises a housing 11, at least one sensor module 12 and a circuit substrate 13.

The housing 11 comprises a bottom cover shell 111, a top cover shell 112 covering the bottom cover shell 111, an accommodation chamber 110 defined in between the top cover shell 112 and the bottom cover shell 111, and a cushion pad 113 affixed to the bottom side of the bottom cover shell 111. The top cover shell 112 of the housing 11 has at least one sensing zone 114 defined in the surface thereof.

The at least one sensor module 12 is disposed at one side relative to the surface of the housing 11 for sensing the presence of an external object, for example, the user's fingers or pen on the surface of the housing 11. The at least one sensor module 12 can be, for example, a mechanical key protruding over the surface of the housing 11, a capacitive or resistive touch panel disposed at the inner side of the surface of the housing 11, or a CCD (charge coupled device), CMOS (complementary metal-oxide semiconductor), DB/IR (direct-beam infrared ray) or DF/IR (diffuse infrared ray) sensor mounted in the accommodation chamber 110 corresponding to the at least one sensing zone 114 of the housing 11.

The circuit substrate 13 is mounted in the accommodation chamber 110 inside the housing 11 carrying multiple electronic components and a circuit layout (not shown). The electronic components include a control module 131, a touch panel 132, a displacement sensor module 133, a transmission module 134 and a power supply module 135. The control module 131 is electrically connected with the touch panel 132, the displacement sensor module 133, the transmission module 134 and the power supply module 135. Each sensor module 12 is also electrically connected with the control module 131. Further, the displacement sensor module 133 can use a CCD (charge coupled device) image sensor, CMOS (complementary metal-oxide semiconductor) image sensor or infrared sensor to match with a LED or laser LED for measuring displacement of the housing 11 of the input device 1 in X-axis and Y-axis. The light reflected by a target passes through the receiver lens and is focused on the sensor. The light quantity distribution of the entire beam spot entering the light receiving element is used to determine the beam spot center and identifies this as the target position. Subject to the functioning of the displacement sensor module 133, the direction and amount of movement of the housing 11 are detected.

The power supply module 135 can be a storage battery or dry battery adapted to provide the circuit substrate 13 with the necessary working power.

The computer 2 and the input device 1 can transmit signal to each other, comprising a receiver module 21 and a driver software 22. The receiver module 21 and the driver software 22 are electrically connected. The receiver module 21 is adapted for receiving signal from the input device 1. The transmission method can be a wireless method or wired method. The receiver module 21 transits the received signal to the driver software 22. The driver software 22 can read and calculate the signal received from the input device 1.

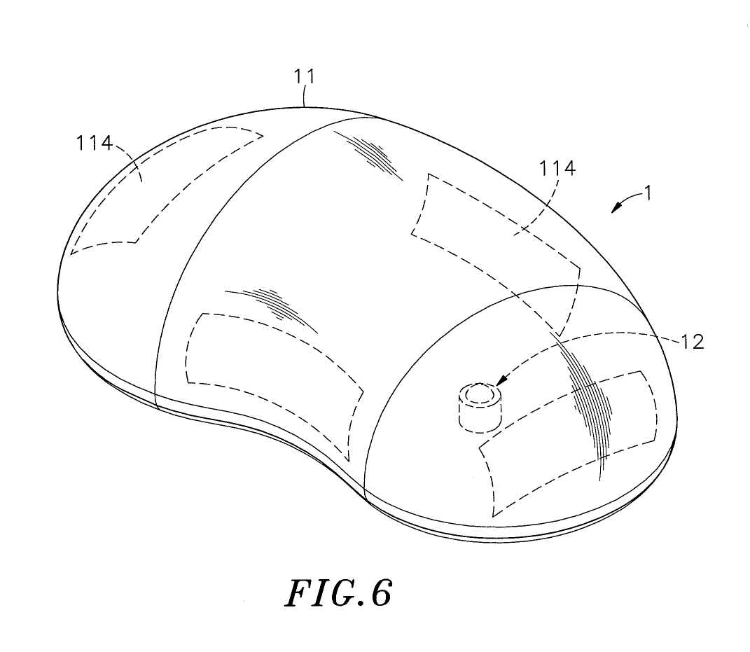

Further, in the embodiment shown in FIG. 1, the housing 11 has one sensing zone 114 defined in the front side of the surface thereof. In an alternate form of the present invention as shown in FIG. 6, the housing 11 has multiple sensing zones 114 defined in the surface thereof at the front and rear sides and the two opposite lateral sides.

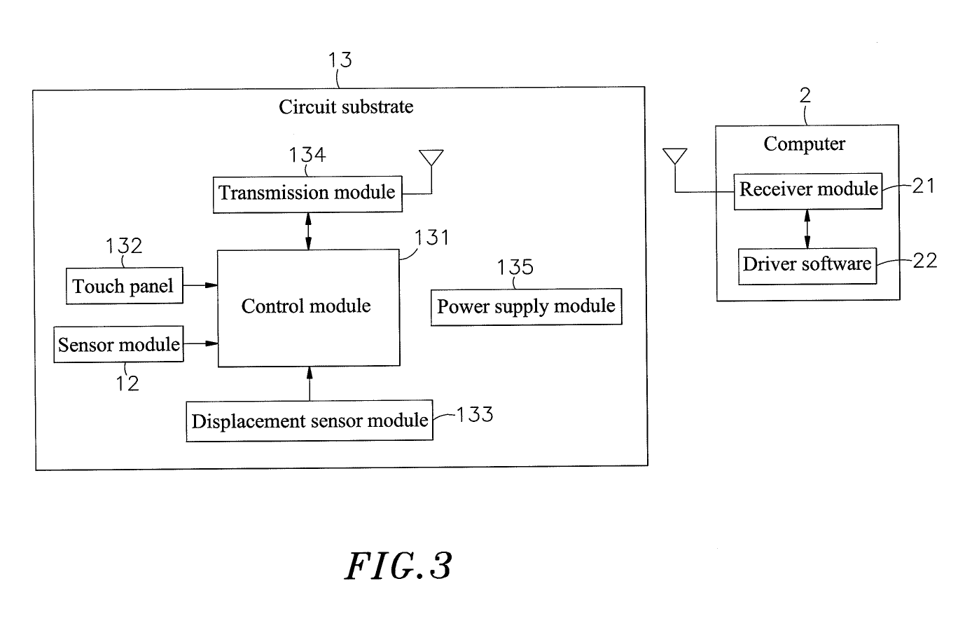

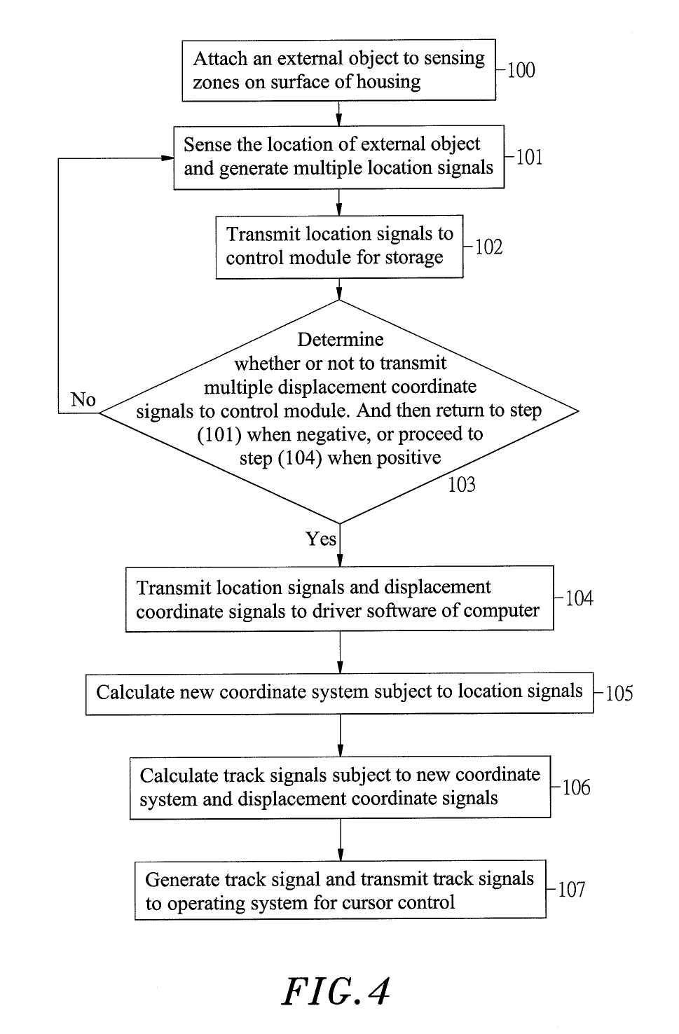

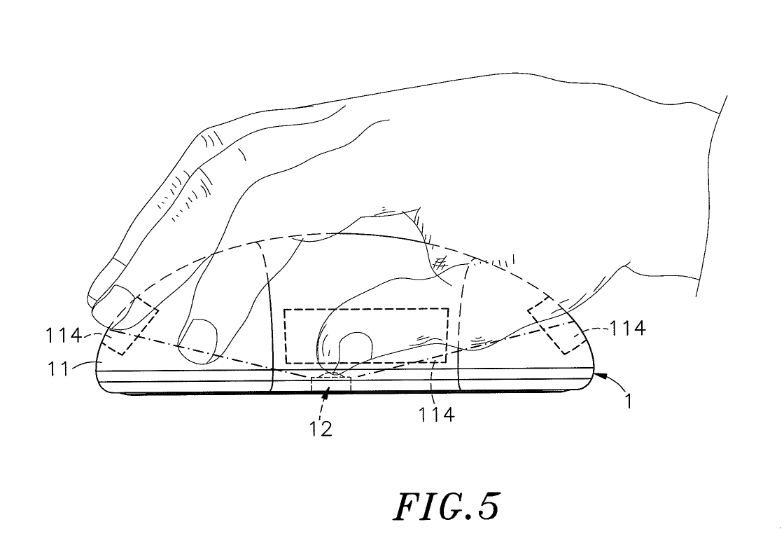

Referring to FIGS. 4 and 5 and FIGS. 3 and 6 again, the multi-direction control processing method runs subject to the following steps:
(100) Attach an external object to the sensing zones 114 on the surface of the housing 11.
(101) Sense the location of the external object and generate multiple location signals.
(102) Transmit the location signals to the control module 131, enabling the control module 131 to store the location signals.
(103) Determine whether or not to transmit multiple displacement coordinate signals to the control module 131. And then return to step (101) when negative, or proceed to step (104) when positive.
(104) Transmit the location signals and the respective displacement coordinate signals to the driver software 22 of the computer 2.
(105) Calculate a new coordinate system subject to the location signals.
(106) Calculate a track signal subject to the new coordinate system and the displacement coordinate signals.
(107) Generate a track signal and transmit the track signal to the operating system for cursor control.

Further, the aforesaid computer 2 can be a desk computer, notebook computer or PDA (personal digital assistant). The multiple sensor modules 12, for example, DF/IR (diffuse infrared ray) sensor modules are mounted in the accommodation chamber 110 corresponding to the respective sensing zones 114 of the housing 11, each having illumination means for illuminating the respective sensing zone 114 with infrared light that arrives at the respective sensing zone 114 from a plurality of different illumination directions, and video imaging means for receiving the diffuse infrared light reflected from the respective sensing zone 114 and for generating a video image of the respective sensing zone 114 based on the diffuse infrared light reflected from the respective sensing zone 114. Subject to the operation of the sensor modules (DF/IR sensor modules) 12, respective location signals are produced and transmitted by the sensor modules (DF/IR sensor modules) 12 to the control module 131. Alternatively, CCD or CMOS image sensors may be used to match with a LED or laser LED for measuring displacement of the housing 11 of the input device 1 in X-axis and Y-axis. In this case, the housing 11 is made of a transparent or semitransparent material so that the sensor modules 12 determine the coordinate location of the external object subject to the shadow of the external object on the surface of the housing 11. It is to be understood that the types of the sensor modules 12 and their installation may be variously embodied for sensing the location of the external object at the surface of the housing 11.

When a user is going to operate the input device 1, that can be made in the form of, for example, a mouse, the user's fingers will be attached to the surface of the housing 11 of the input device 1 corresponding to the sensing zones 114. The sensor modules 12 keep scanning the sensing zones 114 after startup of the input device 1. When the user attach the fingers to the at least one sensing zone 114, the at least one sensor module 12 will sense the coordinate location of the user's fingers at each sensing zone 114 to produce a respective location signal and to send the respective location signal to the control module 131. Upon receipt of each location signal, the control module 131 will store each location signal, and will determine whether or not multiple displacement coordinate signals are received from the displacement sensor module 133. Upon receipt of the location signals and the displacement coordinate signals, the control module 131 will transmit these signals to the receiver module 21 of the computer 2 through the transmission module 134. Upon receipt of the location signals and the displacement coordinate signals from the transmission module 134, the receiver module 21 will transmit these signals to the driver software 22, enabling the driver software 22 to transform the coordinate system subject to the received location signals. Thereafter, subject to the data of the new coordinate system and by means of operation of the formula built in the driver software 22, each displacement coordinate data is transformed, forming a respective new displacement coordinate data, and the new displacement coordinate data is called the track signal, i.e., the track signal is the new displacement coordinate signal transformed by the driver software 22.

The transformation of the coordinate system is executed subject to the predetermined coordinate system and formula stored in the driver software 22 of the computer 2. The predetermined formula is employed subject to the predetermined coordinate system {O:i,j}, i.e., the coordinate system produced subject to the last sensing operation of the at least one sensor module 12 in sensing the at least one sensing zone 114 is used to execute coordinate system transformation, in which O is the coordinate of the reference point, normally indicated by (0,0); i is the coordinate system of x-axis; j is the coordinate system of y-axis, i.e., all x-axis coordinates produced during movement or sensing of the input device 1 belong to i, and all y-axis coordinates produced during movement or sensing of the input device 1 belong to j. If the at least one sensor module 12 senses the presence of the external object at a different location on the surface of the housing 11, a new coordinate system {O′:i′,j′} will be produced.

In more detail, the transformation of a new coordinate system is to define an old coordinate system data {O:i,j} and a new coordinate system data {O′:i′,j′} and then to finish the transformation by means of two steps, i.e., to translate the old coordinate data {O:i,j} into a new coordinate system data {O′:i′,j′} at first, and then to rotate this new coordinate system data O′ through an angle θ=∠(i, i′), thereby obtaining a new coordinate system data {O′:i′,j′}.

O: the reference point of the old coordinate system.

i: the transverse axis of the old coordinate system.

J: the longitudinal axis of the old coordinate system.

O′: the reference point of the new coordinate system.

i′: the transverse axis of the new coordinate system.

j′: the longitudinal axis of the new coordinate system.

θ: the angle of rotation between the new and old coordinate systems.

(X, Y): the coordinates of the old coordinate system.

(X′, Y′): the coordinates of the new coordinate system.

a: the displacement amount of X′ relative to the transverse axis of the old coordinate system.

b: the displacement amount of Y′ relative to the transverse axis of the old coordinate system.

According to the aforesaid predetermined formula, when the coordinates of the old coordinate data {O:i,j} and the new coordinate system data {O′:i′,j′} are (X, Y) and (X′, Y′) respectively, X, Y are respectively translated into X′, Y′, in which X′, Y′ can be:

{x′=(x−α)cos θ+(y−b)sin θ=x cos θ+y sin θ−a cos θ−b sin θ

{y′=(x−α)sin θ+(y−b)cos θ=−x sin θ+y cos θ+a sin θ−b cos θ

The aforesaid formula is simply an example for explanation purpose only but not to be used as a limitation.

Thus, the driver software 22 can translate the received multiple displacement coordinate signals into respective new displacement coordinate signals, or the said track signals, subject to the new coordinate system, and then send these track signals to the operating system, for example, application program, for cursor reading and application program execution to achieve multi-direction control of the input device 1.

On the other hand, when a user attach the fingers to the surface of the housing 11 of the input device 1 over the sensing zones 114, the thumb and the little finger will be respectively rested on the two sensing zones 114 at the two opposite lateral sides of the housing 11, and the index finger and the middle finger are rested will be rested on the sensing zone 114 at the front side of the housing 11. At this time, the sensor modules 12 will sense the coordinate locations of the user's fingers at the respective sensing zones 114. At this time, the area of the thumb at one of the sensing zones 114 will be larger than the area of the little finger at another of the sensing zones 114, and a relatively greater number of coordinate locations will be generated for a relative larger sensed area to form multiple location signals. After receipt of multiple location signals from the sensor modules 12 by the control module 131, the control module 131 will store the received location signals. After receipt of multiple displacement coordinate signals from the displacement sensor module 133 by the control module 131, the control module 131 will transmit the received location signals and displacement coordinate signals to the receiver module 21 of the computer 2, and the receiver module 21 will transmit the received location signals and displacement coordinate signals to the driver software 22, enabling the driver software 22 to determine the user's thumb or little finger to be located on the surface of the housing 11 at the left side or right side (the area of the thumb is relatively larger), knowing that the user is using the left hand or right hand to operate the input device 1. Thus, the invention enhances the flexibility of the use of the input device 1.

This input device 1 has multi-direction and left and right hand control functions, and therefore the operation of the input device 1 is free from limitations in direction or left/right hand operation, i.e., a left-handed user as well as a right-handed user can operate the input device 1 in any direction to control the operation of the computer 2. When a left-handed or right-handed user operates the input device 1 in any direction, the driver software 22 of the computer 2 can make judgment and calculation to define the coordinate location and to establish a new coordinate system. After transmission of new location signals and new displacement coordinate signals by the input device 1 to the receiver module 21 of the computer 2, the driver software 22 of the computer 2 will calculate the new track signals subject to the new location signals and new displacement coordinate signals.

The above description is simply for understanding of the features of the present invention but not intended for use as limitations of the scope of the invention. Further, the sensor modules 12 can be direct-beam type sensor modules, for example, DB/IR (direct-beam infrared) sensor modules evenly arranged inside the housing 11 to determine the location of an external object on the surface of the housing 11 subject to shading status of the surface of the housing 11. Alternatively, mechanical key switches may be evenly arranged on the surface of the housing 11 so that when an external object touches one particular area of the surface of the housing 11, the respective key switch will be switched to produce a signal indicative of the location of the external object on the surface of the housing 11. Either of the aforesaid methods can cause the sensor modules 12 to produce location signals subject to the location of the external object rested on the surface of the housing 11, and the driver software 22 of the computer 2 will update the storage coordinate system subject to the location signals provided by the sensor modules 12. Thus, the input device 1 can be operated in any direction to control the computer 2.

Further, the sensing zones 114 can cover the whole area or a part of the surface of the housing 11. In the drawings, the arrangements of the sensing zones 114 are examples for illustration only, but not intended for use as limitations.

In conclusion, the input device multi-direction control processing method of the present invention has advantages and features as follows:
1. The input device multi-direction control processing method runs by means of the sensor modules 12 of the input device 1 to detect the presence of an external object on the surface of the housing 11 so that when the sensor modules 12 transmit location signals to the control module 13 when sensed the presence of an external object on the surface of the housing 11. Upon receipt of the location signals from the sensor modules 12, the control module 13 will immediately determine whether or not it has received displacement coordinate signals from the displacement sensor module 133, and will then, if positive, transmit the received location signals and displacement coordinate signals to the computer 2, enabling the driver software 22 of the computer 2 to generate a new coordinate system subject to the received location signals and to translate every displacement coordinate signal into a respective track signal. Thus, every operating signal produced by the input device 1 in any direction can be read by means of coordinate system transformation.
2. The sensor modules 12 of the input device 1 can detect the location of an external object on the surface of the housing 11 and generate multiple location signals and transmit generated location signals to the computer 2 for enabling the driver software 22 of the computer 2 to determine the type of the external object (user's thumb or little finger) on the surface of the housing 11 subject to the location signals, and therefore the driver software 22 can know that the user is using his (her) left hand or right hand in operating the input device 1.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. An input device multi-direction control processing method used in an input device having a housing thereof at least one sensor module and a circuit substrate carrying a control module, a touch panel, a displacement sensor module, a transmission module and a power supply module to control a computer comprising a driver software, the input device multi-direction control processing method comprising the steps of:
(a) detecting the location of an external object attached to the surface of the housing of the input device and generating at least one location signal;
(b) transmitting said at least one location signal to said control module, for enabling said control module to store said at least one location signals;
(c) determining whether or not to transmit multiple displacement coordinate signals to said control module, and then returning to step (a) when negative, or proceeding to step (d) when positive;
(d) transmitting every said location signal and every said displacement coordinate signal to said driver software of said computer;
(e) said driver software calculating a new coordinate system subject to every location signal received; and
(f) said driver software calculation a track signal subject to said new coordinate system and every said displacement coordinate signal received.

2. The input device multi-direction control processing method as claimed in claim 1, wherein each said location signal is a coordinate location produced subject sensing of said at least one sensor module to detect the presence of an external object on one sensing zone at the surface of said housing.

3. The input device multi-direction control processing method as claimed in claim 1, wherein each said displacement coordinate signal is a set of displacement coordinates produced subject to movement of said housing detected by said displacement sensor module.

4. The input device multi-direction control processing method as claimed in claim 1, further comprising a sub-step in which, after said driver software of said computer received every said location signal, said driver software of said computer determines the external object to be a user's left hand or right hand subject to the location of said external object at left or right side of the surface of said housing.
